(19) United States
(12) Patent Application Publication
(10) Pub. No.: US 2011/0000050 A1
(43) Pub. Date: Jan. 6, 2011

(54) Hinge For A Refined Built-In Appliance

(76) Inventor: Oreste Lanzani, Bagnolo Mella (Brescia) (IT)

Correspondence Address: Cozen O''''Connor, 277 PARK AVENUE, 20th Floor, NEW YORK, NY, 10172, US

(21) Appl. No.: 12/691,076

(22) Filed: Jan. 21, 2010

Related U.S. Application Data
(60) Provisional application No. 61/146,701, filed on Jan. 23, 2009.

(30) Foreign Application Priority Data
Jan. 23, 2009 (IT) MI2009A000071

(51) Int. Cl. E05D 5/02

(52) U.S. Cl. 16/382

(57) ABSTRACT

A hinge for a domestic appliance, in particular a refrigerator, of the type adapted to be built-into a furnishing element comprising a body having a seat adapted to contain said domestic appliance and an opening for insertion of said domestic appliance adapted to be closed at least partially by a panel, said hinge being adapted to mutually connect at least one door of said domestic appliance to a body of said domestic appliance, and said door to said panel, so that by closing the door of the domestic appliance also said panel is closed and closes the seat of the furnishing element into which said domestic appliance is built.

The present invention relates to a hinge according to the precharacterizing part of claim 1

Hinges of the aforesaid type have been known for some time; they are, by way of example, described in U.S. Pat. No. 5,471,709 and are marketed with the trademark “INGOL”.

Prior art hinges are used to support doors of refrigerators of small or medium dimensions but to date have never been used for doors of refrigerators of large dimensions, or for doors that can weigh up to 100 kg and open to an angle of over 100°.

Furthermore, even if the known hinges allow considerable opening angles of the door they are connected to, for example up to opening values of 99°, these hinges do not always satisfy the built in domestic appliances producer needs, because they ask opening angles greater than 99°, for example angles of 115° and more. The object of the present invention is to produce a hinge whose components are dimensioned and structured to be able to support doors of refrigerators of large dimensions and which can allow the door to open to an angle greater than 99° and which can arrive to 115° and more. These and other objects that will be evident to those skilled in the art are achieved with a hinge according to the appended claims.

For a better understanding of the present invention the accompanying drawings are provided by way of non-limiting example, wherein:

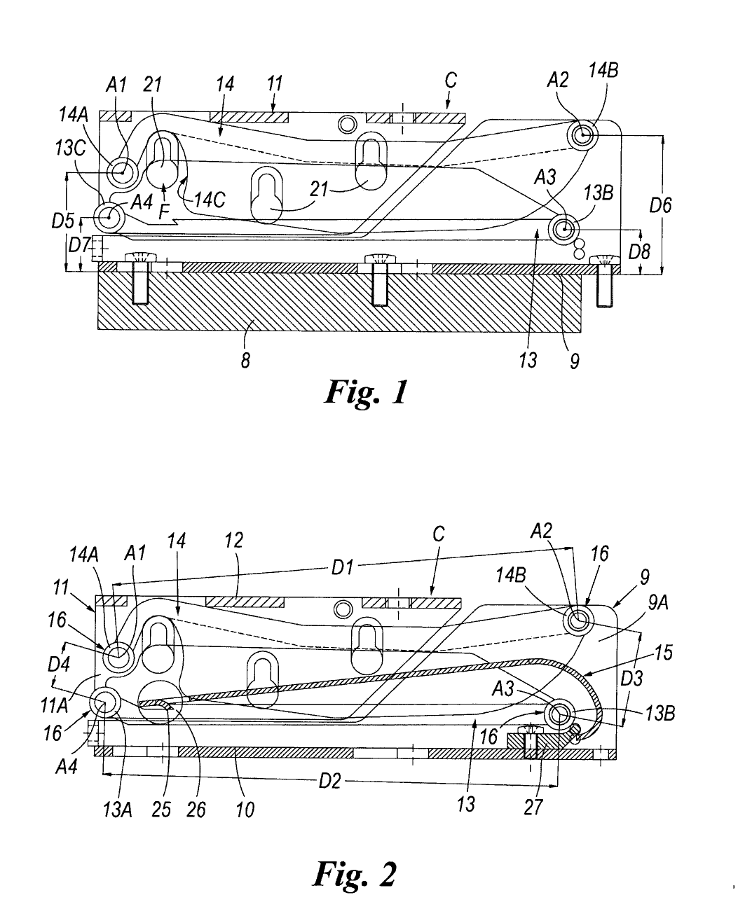

FIGS. 1 and 2 show partially longitudinally sectioned schematic top views of a hinge according to the invention,

FIG. 3 shows a cross sectional schematic view of the hinge,

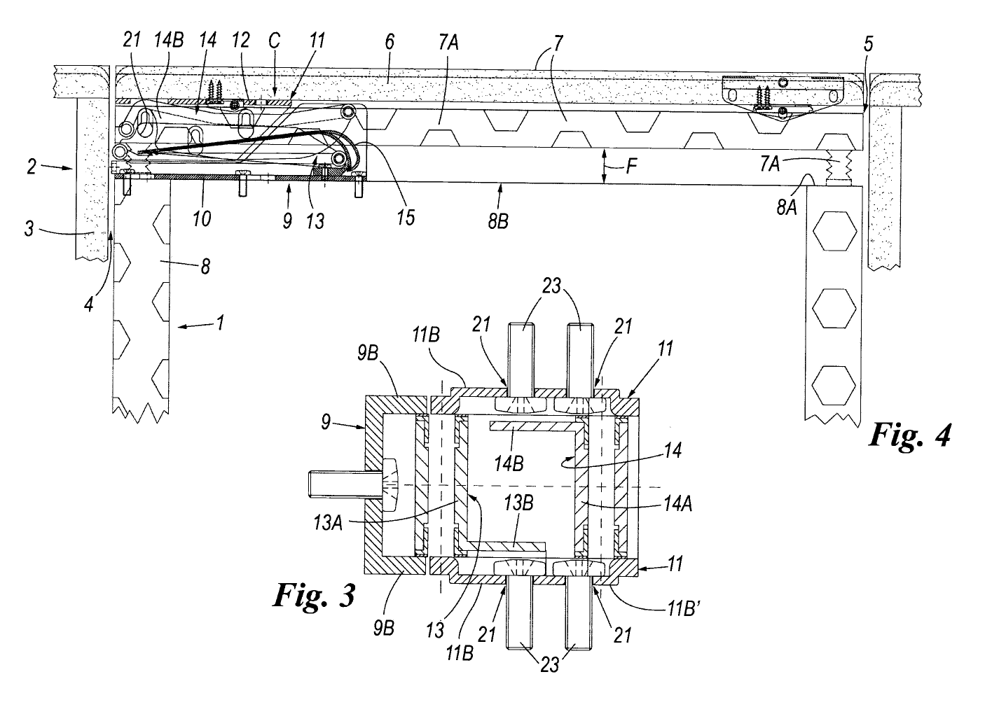

FIGS. 4, 5, 6 and 7 show top views of the hinge, partially sectioned and in different using positions (0°, 76°, 90° and 115°), when it is applied to a refrigerator built into a furniture unit and with a panel connected to the door of the refrigerator,

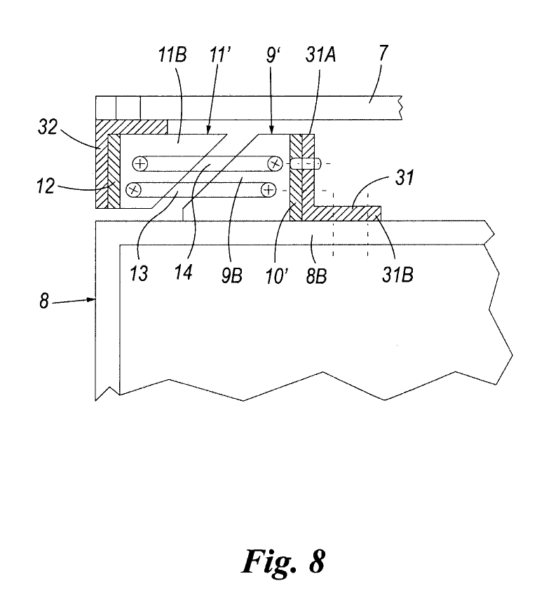

FIG. 8 shows a partially sectioned schematic top view of a variant.

With reference to the aforesaid figures, they show a hinge for a domestic appliance 1 (partially represented in FIG. 4), in particular a refrigerator, of the type adapted to be built into a furnishing element 2 (partially represented in FIG. 4) comprising a body 3 having a seat 4 adapted to contain said domestic appliance and an opening 5 for insertion of said domestic appliance adapted to be closed at least partially by a panel 6, said hinge being adapted to mutually connect at least one door 7 of said domestic appliance to a body 8 of said domestic appliance and said door 7 to said panel 6, so that by closing the door of the domestic appliance also said panel is closed and closes the seat of the furnishing element into which said domestic appliance is built. The hinge comprises:
a first support structure 9 comprising a first wall 10 adapted to be connected to the body 8 of said domestic appliance, or to a front wall or load bearing structure 8B thereof;
a second support structure 11 comprising at least a second wall 12 adapted to be connected to said door 7 and/or to said panel 6;
first 14 and second 13 connecting elements adapted to mutually connect said first 9 and second 11 support structure;
and a return element 15 interacting with one (the element 13) of said two connecting elements.

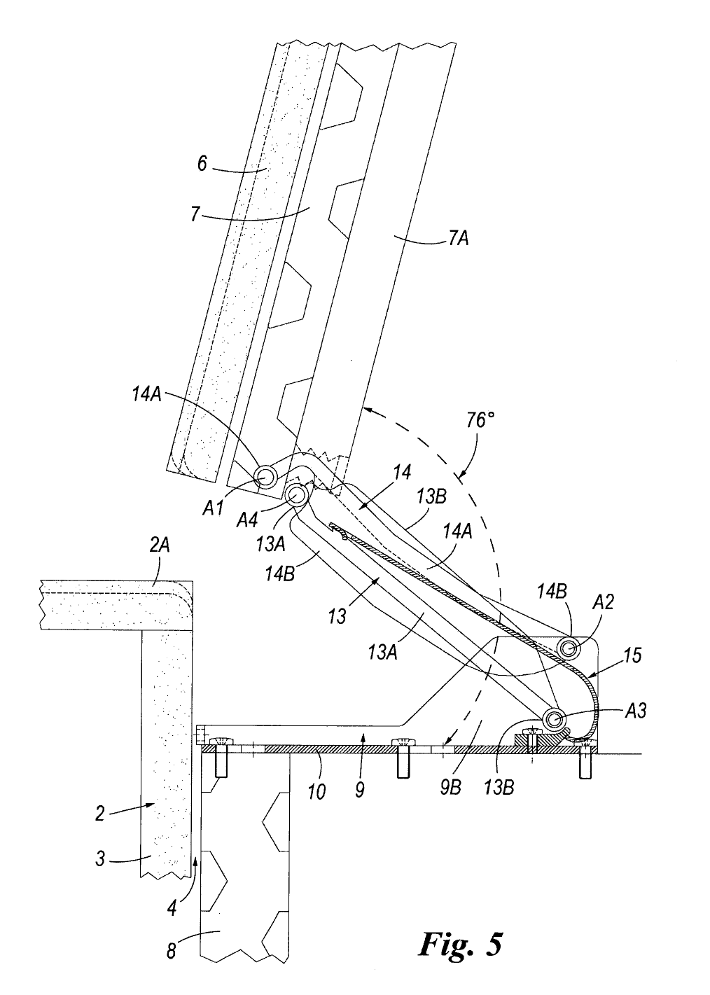

The first and second connecting elements 14, 13 and the first and second support structure 9, 11 form a hinged quadrilateral lying in one or more planes, perpendicular to the door 7 of the domestic appliance. The sides of the hinged quadrilateral are formed by: the first connecting element 14, by the second connecting element 13, and by at least a first 9A and a second portion 11A respectively of said first and second support structure 9 and 11. The quadrilateral is adapted to define means to open and close the door 7 and the panel 6 so that said door and said panel do not interfere with an angular portion 2A (FIGS. 5-7) of the body 2 into which the domestic appliance is built.

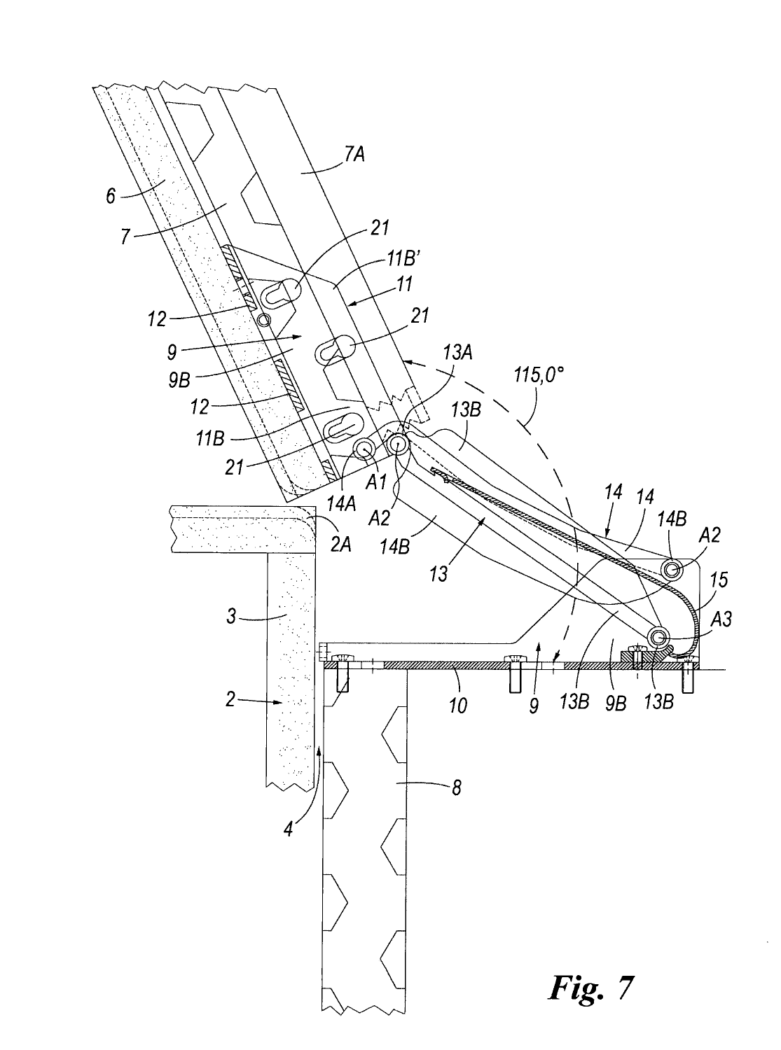

The quadrilateral comprises means 16 for hinging end portions 13A, 13B, 14A, 14B of said first and second connecting elements 14 and 13 to said first and second portions 9A and 11A of said support structures 9 and 11. Preferably, said hinge means 16 are provided with pins (not shown) passing through cylindrical seats provided in the end portions of the connecting elements 13 and 14 and through holes produced in wings 9B and 11B (FIG. 7) of the support structures 9 and 11, wherein said wings are perpendicular to the vertical connecting walls 10 and 12 of said structures and diverge therefrom. The connecting walls 10 and 12 are substantially mutually parallel when the quadrilateral is in the closed position (C FIGS. 1, 2 and 4); in said closed position of the quadrilateral also said door 7 and said panel 6 being closed. In said closed position C the hinging axes A1, A2, A3, A4 of the quadrilateral define:
a first distance D1 defined by the line passing through the hinging axes A1 and A2 provided in the first 14A and in the second 14B end of the first connecting element 14,
a second distance D2 defined by the line passing through the hinging axes A3, A4 provided in the first 13A and in the second 13B end of the second connecting element 13,
a third distance D3 defined by the line passing through the hinging axes A2 and A3 provided in the second end 14B of the first element 14 and the second end 13B of the second element 13,
a fourth distance D4 defined by the line passing through the hinging axes A4, A1 provided in the first end 13A of the second element 13 and the first end 14A of the first element 14. According to the invention:
the dimensions of the first, second, third and fourth distance D1, D2, D3, D4 all differ from one another,
the size ratio between the first D1 and the fourth D4 distance is between: 8 and 10 or: 8=<D1/D4<=10
the size ratio between the second D2 and the fourth D4 distance is between: 8 and 10 or: 8<=<D2/D4<=10
the size ratio between the third D3 and the fourth D4 distance is between: 1.5 and 2.5 or: 1.5<=<D3/D4<=2.5

Advantageously, according to a first preferred embodiment:
the first distance D1 is equal to: 176.7 mm
the second distance D2 is equal to: 174.1 mm
the third distance D3 is equal to: 37.2 mm
the fourth distance D4 is equal to: 18.2 mm,
and the above size ratios are between the following values:
9=<D1/D4<=10,
9<=<D2/D4<=10
1.5<=<D3/D4<=2.5.

According to a second preferred embodiment:
the first distance D1 is equal to: 174.8 mm
the second distance D2 is equal to: 178.0 mm
the third distance D3 is equal to: 37.0 mm
the fourth distance D4 is equal to: 19.9 mm,
and the above size ratios are between the following values:
8=<D1/D4<=10,
8<=<D2/D4<=10
1.5<=<D3/D4<=2.5.

Due to this particular type of sizing of the axes of the quadrilateral, it has surprisingly been found that it is possible to produce a hinged quadrilateral and consequently a hinge that is: capable of supporting doors of refrigerators of large dimensions, that can weigh even up to 100 kg, with door opening angles, respectively, equal to 115° for the first embodiment mentioned above, and 120° for the second embodiment.

Moreover it is to be noted that the second embodiment allows to realize a hinged quadrilateral wherein, contrary to the hinged quadrilater of the known hinges, the distance D2 (defined by the line passing through the hinging axes A3, A4 provided in the first 13A and in the second 13B end of the second connecting element 13) is greater than the distance D1 (defined by the line passing through the hinging axes A1 and A2 provided in the first 14A and in the second 14B end of the first connecting element 14).

The invention shall not be considered limited to the two embodiments mentioned above but it shall be considered as comprising every quadrilateral having the four distances D1, D2, D3, D4 mentioned above multiplied with an identical factor, comprised between zero and two, or rather for every embodiment for which the following conditions apply:
a) the dimensions of said first, second, third and fourth distance (D1, D2, D3, D4) all differ from one another,
b) the first distance (D1) is comprised between 172.8 mm and 178.7 mm or in a range limited by said values multiplied by a factor K1, or rather:
(172.4 mm×K1)<=D1<=(178.7 mm×K1),
c) the second distance (D2) is comprised between 172.1 mm and 180 mm or in a range limited by said values multiplied by a factor K1, or rather:
(172.1 mm×K1)<=D2<=(180 mm×K1),
d) the third distance (D3) is comprised between 35 mm and 39.2 mm or in a range limited by said values multiplied by a factor K1, or rather:
(35 mm×K1)<=D3<=(39.2 mm×K1),
e) the fourth distance (D4) is comprised between 16.2 mm and 21.9 mm or in a range limited by said values multiplied by a factor K1, or rather:
(16.2 mm×K1)<=D4<=(21.9 mm×K1),
f) wherein K1 is comprised between 0 and 2, or rather: 0<K1 <=2

Moreover, with reference to the first preferred embodiment indicated above, in the closed position C of the hinge the hinging axes A1, A2, A3, A4 of the quadrilateral define (see FIG. 1), with respect to the first wall 10 of the first support structure 9 or with respect to a front wall or load bearing structure 8B of the body 8 of the refrigerator (as described below):
a first distance D5, with respect to the first end 14A of the first connecting element 14,
a second distance D6, with respect to the second end 14B of the first connecting element 14,
a third distance D7, with respect to the first end 13A of the second connecting element 13,
a fourth distance D8, with respect to the second end 13B of the second connecting element 13; according to the invention in said closed position the dimensions of said first, second, third and fourth distance D5-D8 all differ from one another, and advantageously:
the first distance D5 is equal to: 38.5 mm+n mm
the second distance D6 is equal to: 54 mm+n mm
the third distance D7 is equal to: 21 mm+n mm
the fourth distance D8 is equal to: 17.5 mm.+n mm
where n is a number between −50 mm and +300 mm, or −30 mm<=n=<+300 mm. In other words, the distances D5-D8 indicated (38,5, 54,0, 17,5, 21,0) must be considered preferred, but in the case in which due to design requirements it is necessary to increase or decrease the distance F (FIG. 4) between the front edge 8B (FIG. 4) of the body 8 of the refrigerator and the door 7 of the refrigerator these distances can all be increased or decreased by a same correction addend (as the hinge can also be partially built into the body 8 of the refrigerator or positioned in a cantilever fashion outside said body).

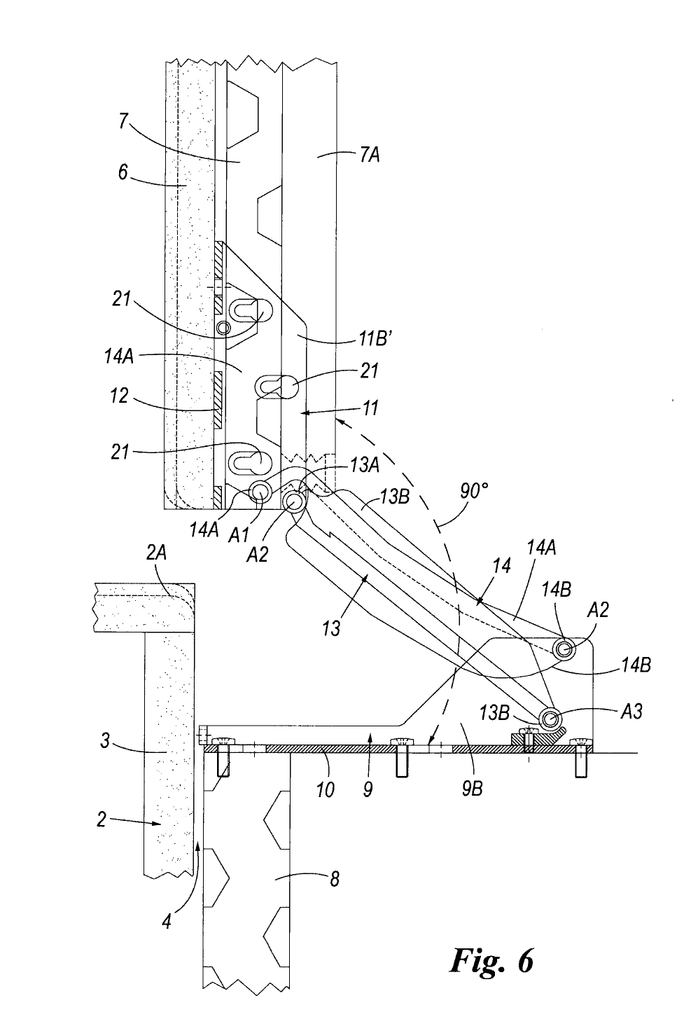

Advantageously, the invention provides that the fixing points of the door 7 of the refrigerator to the hinge are produced in the upper head 7A (FIG. 4) of the door instead of in the front wall thereof as is currently the case. For this purpose, in the upper 11B and lower 11B′ wings (FIG. 6) of the support structure 11 adapted to be connected to the door 7, three slot shaped through holes 21 are provided for passage of screws 23 (FIG. 3) adapted to connect said structure 11 to the door. Due to the fact that the holes 21 are provided both in the upper 11b and in the lower 11 B′ wing, the hinge can be connected either to the lower edge or to the upper edge of the door; naturally, in the case where it is used as an upper hinge the holes provided in the lower wing 11B′ will be used, while if it is used as lower hinge the holes of the upper wing 11B will be used. It must also be emphasized that due to the fact that the holes 21 are slot shaped, during assembly of the door 7 to the hinge it is possible to adjust the position of the door in a direction M (FIG. 4) perpendicular thereto and, after the correct position has been achieved, to finally tighten the screws 23. In this way rotation of the door can be set by means of optimal coupling of the magnetic seal 7A (FIG. 4) on the door 7 with the front of the furnishing element 1. It must be emphasized that, as can be seen in FIG. 2 and will be described in detail below, the connection elements 14 and 13 are structured so that when the hinge is closed they still allow one of the holes 21 (indicated with the arrow F in FIG. 1) to be reached, so that it is possible to tighten at least one of the screws 23 after the door has been positioned.

It must be emphasized that the solutions relative to the position and structure of the holes 21 can advantageously also be adopted in the hinges already on the market and independently of the characteristics claimed in the main claim.

Advantageously, both the first 14 and the second 13 connecting element are provided with a first connecting rod 13A, 14A substantially flat in shape, preferably with an arched or rectilinear profile, and lying in a vertical plane, and a wing 13B, 14B which for the first element 14 diverges from the upper edge of the connecting rod 14A, while for the other connecting element 13 it diverges from the lower edge of the connecting rod 13A. These wings 14B, 13B are dimensioned and structured so that during the rotation movement of the elements 14 and 13 of the quadrilateral of the hinge, they always close the open space that is created between one connecting rod 13A and the other 14A so as to prevent a user of the domestic appliance from placing a finger between said parts of the hinge or so that the hinge is adapted to pass the “finger safety test”. Due to the wings 14B, 13B, plastic covers, which are unsightly and of doubtful effectiveness with respect to the finger safety test, do not require to be provided for the connecting rods of the hinge, and moreover connecting elements can be produced with greater bending strength with respect to elements provided with only one connecting rod without wings. It must be mentioned that the wings 14B and 13B are both provided with a bevel 14C (FIG. 1) structured so that when the hinge is in the closed position it is possible to reach one of the holes 21 (indicated with the arrow F in FIG. 1) so that at least one of the screws 23 can be tightened after the door has been positioned. It must be emphasized that the solutions relative to the shape of the connecting elements can advantageously also be adopted in the hinges already on the market and independently of the characteristics claimed in the main claim.

Advantageously, with reference to the first preferred embodiment indicated above, the return element 15 interacting with the connecting element 13 is a leaf spring having a simplified coupling with the connecting rod 13A of said element 13. In fact, this coupling is obtained by producing by means of stamping, at one end of the leaf of the spring, a bent tongue 25 with a wide radius of curvature which engages in a tooth 26 provided on the connecting rod 13. This allows springs to be formed with materials already hardened and therefore with significantly lower costs with respect to those of the springs currently used in prior art hinges. The other end of the leaf spring 15 is connected to the hinge free to rotate at least partially around a corner 27 (FIG. 2) or around a pin (not shown) of the hinge.

It must be emphasized that the solutions relating to the spring 15 can advantageously also be adopted in the hinges already on the market and independently of the characteristics claimed in the main claim.

Advantageously, the hinge has a substantially parallelepiped shape in the closed position and the connecting elements 14, 13 are substantially housed inside the support structures 9, 11, or between the vertical walls 10 and 12 of said structures and between horizontal walls or wings diverging from the upper and lower edges of said vertical walls.

FIG. 8 schematically shows a further variant of the hinge wherein the support structures 9′ and 11′ are no longer provided with the vertical walls 10 and 12 which when the hinge is closed are parallel with the door 7 of the refrigerator; according to this variant the wings 9B and 11B of the structures are mutually connected by a wall 10′ and 12′ which when the hinge is closed are perpendicular to the door 7 of the refrigerator.

According to this solution the structure 9′ is connected to the front 8b of the refrigerator, for example by means of an L-shaped element 31 comprising a first wall 31A, for example connected by means of screws to the wall 10′ of the structure 9, and a second wall 31B perpendicular to the first, for example connected by means of screws to the front wall or structure 8B of the refrigerator. Analogously, also the other structure is connected to the door 7 by means of an L-shaped element 32.

According to this variant, instead of referring to the wall indicated with 10, in the embodiment of FIGS. 4-7, the distances D5, D6, D7, D8 mentioned above refer to the front wall or load bearing structure indicated with 8B in the embodiment of FIG. 8 (substantially coincident with said wall 10).

1. A hinge for a domestic appliance (1), in particular a refrigerator, of the type adapted to be built into a furnishing element (2) comprising a body (3) having a seat (4) adapted to contain said domestic appliance and an opening (5) for insertion of said domestic appliance (1) adapted to be closed at least partially by a panel (6), said hinge being adapted to mutually connect at least one door (7) of said domestic appliance to a body (8) of said domestic appliance, and said door (7) to said panel (6), so that by closing the door of the domestic appliance also said panel is closed and closes the seat (4) of the furnishing element (2) into which said domestic appliance is built, said hinge comprising:
a first support structure (9) adapted to be connected to a load bearing front structure or wall (8B) of the body (8) of said domestic appliance (1),
a second support structure (11) adapted to be connected to said door (7) and/or to said panel (6),
first (14) and second (13) connecting elements adapted to mutually connect said first (9) and second (11) support structure,
and a return element (15) interacting with at least one of said two connecting elements (14, 13),
said first and second connecting elements (14, 13) and the first and second support structure (9, 11) forming a hinged quadrilateral lying in one or more planes, perpendicular to said door (7),
the sides of said hinged quadrilateral being formed by: said first connecting element (14), said second connecting element (13), and by at least a first (9A) and a second (11A) portion respectively of said first (9) and second (11) support structure,
said quadrilateral being adapted to define means to open and close said door (7) and said panel (6) so that said door and said panel do not interfere with an angular portion (2A) of said body (2) into which the domestic appliance is built,
said quadrilateral comprising means (16) for hinging end portions (13A, 13B, 14A, 14B) of said first and second connecting elements (13, 14) to said first and second portions (9A, 11A) of said support structures (9, 11),
in a closed position (C) of the quadrilateral, or of the hinge, said door (7) and said panel (6) also being closed,
in said closed position (C) the hinging axes (A1, A2, A3, A4) of the quadrilateral defining:
a first distance (D1) defined by the line passing through the hinging axes (A1, A2) provided in the first (14A) and in the second (14B) end of the first connecting element (14),
a second distance (D2) defined by the line passing through the hinging axes (A3, A4) provided in the first (13A) and in the second (13B) end of the second connecting element (13),
a third distance (D3) defined by the line passing through the hinging axes (A2, A3) provided in the second end (14B) of the first element (14) and the second end 13B of the second element (13),
a fourth distance (D4) defined by the line passing through the hinging axes (A4, A1) provided in the first end (13A) of the second element (13) and the first end (14A) of the first element (14), characterized in that:
the dimensions of said first, second, third and fourth distance (D1, D2, D3, D4) all differ from one another,
the first distance (D1) is comprised between 172.8 mm and 178.7 mm or in a range limited by said values multiplied by a factor K1, or rather:
(172.4 mm×K1)<=D1<=(178.7 mm×K1),
the second distance (D2) is comprised between 172.1 mm and 180 mm or in a range limited by said values multiplied by a factor K1, or rather:
(172.1 mm×K1)<=D2<=(180 mm×K1),
the third distance (D3) is comprised between 35 mm and 39.2 mm or in a range limited by said values multiplied by a factor K1, or rather:
(35 mm×K1)<=D3<=(39.2 mm×K1),
the fourth distance (D4) is comprised between 16.2 mm and 21.9 mm or in a range limited by said values multiplied by a factor K1, or rather:
(16.2 mm×K1)<=D4<=(21.9 mm×K1),
wherein K1 is comprised between 0 and 2, or rather: 0<K1 <=2

2. The hinge according to claim 1, characterized in that:
the size ratio between the first (D1) and the fourth (D4) distance is between: 9 and 10 or that: 9=<D1/D4<=10
in that the size ratio between the second (D2) and the fourth (D4) distance is between: 9 and 10 or that: 9<=<D2/D4<=10
in that the size ratio between the third (D3) and the fourth (D4) distance is between: 1.5 and 2.5 or that: 1.5<=<D3/D4<=2.5.

3. The hinge according to claim 1, characterized in that:
the first distance (D1) is equal to: 176.7 mm or said value multiplied by a factor K2, or rather: D1=(176.7 mm×K2),
in that the second distance (D2) is equal to: 174.1 mm or said value multiplied by a factor K2, or rather: D2=(174.1 mm×K2),
in that the third distance (D3) is equal to: 37.2 mm or said value multiplied by a factor K2, or rather: D3=(37.2 mm×K2),
in that the fourth distance (D4) is equal to: 18.2 mm or said value multiplied by a factor K2, or rather: D4=(18.2 mm×K2),
wherein K2 is comprised between 0 and 2, or rather: 0<K2<=2.

4. The hinge according to claim 1, characterized in that:
the first distance (D1) is equal to: 174.8 mm or said value multiplied by a factor K3, or rather: D1=(174.8 mm×K3),
in that the second distance (D2) is equal to: 178 mm or said value multiplied by a factor K3, or rather: D2=(178 mm×K2),
in that the third distance (D3) is equal to: 37 mm or said value multiplied by a factor K3, or rather: D3=(37 mm×K3),
in that the fourth distance (D4) is equal to: 19.9 mm or said value multiplied by a factor K3, or rather: D4=(19.9 mm×K3),
wherein K3 is comprised between 0 and 2, or rather: 0<K3<=2.

5. The hinge according to claim 1, characterized in that: the the second distance (D2) is greater than the first distance (D1).

6. The hinge according to claim 1, wherein in said closed position (C) the hinging axes (A1, A2, A3, A4) of the quadrilateral define, with respect to a first wall (10), adapted to be connected to the body (8) of the first support structure (9), or with respect to a front wall or front load bearing structure (8B) of said body (8):
a first distance (D5), with respect to the first end (14A) of the first connecting element (14),
a second distance (D6), with respect to the second end (14B) of the first connecting element (14),
a third distance (D7), with respect to the first end (13A) of the second connecting element (13),
a fourth distance (D8), with respect to the second end (13B) of the second connecting element (13);
characterized in that in said closed position (C):
the first distance (D5) is equal to: 38.5 mm+n mm
the second distance (D6) is equal to: 54 mm+n mm
the third distance (D7) is equal to: 21 mm+n mm
the fourth distance (D8) is equal to: 17.5 mm.+n mm
where n is a number between −50 mm and +300 mm, or −30 mm<=n=<+300 mm.

7. The hinge according to claim 1, characterized in that the support structure (11) adapted to be connected to the door (7) is provided diverging from the wall (12) adapted to be connected to the door (7) and/or to said panel (6), an upper wing (11B) and a lower wing (11B′) and in that at least one through hole (21) is provided in at least one of said wings for passage of a screw (23) adapted to connect said structure (11) to the door.

8. The hinge according to claim 1, characterized in that both the first (14) and the second (13) connecting element are provided with a first connecting rod (13A, 14A) substantially flat in shape and lying in a vertical plane, and a wing (13B, 14B), adapted during the rotation movement of said connecting rods (13A, 14A) to close the open space that is created between one connecting rod (13A) and the other (14A) so as to prevent a user of the domestic appliance from placing a finger between said connecting rods or so that the hinge is adapted to pass the “finger safety test”.

9. The hinge according to claim 8, characterized in that the wings (13B, 14B) diverge from opposite edges of the respective connecting rods (13A, 14A).

10. The hinge according to claim 8, characterized in that at least one of the wings (13B, 14B) is provided with a bevel (14C) structured so that when the hinge is in the closed position (C) it is possible to reach one of the holes (21) and the respective screw (23) provided in the support structure (11) for connecting the door (7) to said structure.

11. The hinge according to claim 8, characterized in that the return element (15) interacting with the connecting element (13) is a leaf spring having a coupling element (25); said coupling element (25) comprising at one end of the leaf of the spring a tongue (25) which engages in a tooth (26) provided in the connecting rod (13).

12. The hinge according to claim 1, characterized in that it has a substantially parallelepiped shape in the closed position.
